(19) United States
(12) Patent Application Publication
(10) Pub. No.: US 2025/0216245 A1
(43) Pub. Date: Jul. 3, 2025

(54) FLUID LEVEL MONITORING SYSTEM

(71) Applicant: Midmark Corporation, Versailles, OH (US)

(72) Inventor: Austin Lowder, Greenville, OH (US)

(21) Appl. No.: 18/985,154

(22) Filed: Dec. 18, 2024

Related U.S. Application Data
(60) Provisional application No. 63/616,009, filed on Dec. 29, 2023.

(51) Int. Cl. G01F 23/263

(52) U.S. Cl. CPC G01F 23/266

(57) ABSTRACT

The present disclosure provides a fluid level monitoring system comprising a microcontroller, an oscillator configured to generate an output signal having a frequency, and a probe coupled with the oscillator. The probe comprises a first wire and a second wire having a capacitance therebetween that varies as a function of the presence of fluid around the probe. The frequency of the output signal varies as a function of the capacitance between the two wires. The microcontroller is configured to determine the amount of fluid proximate the probe based on the frequency of the output signal. The system enables accurate fluid level monitoring using simple components and signal processing techniques.

### REFERENCE TO RELATED APPLICATION

This application claims priority of U.S. provisional patent application Ser. No. 63/616,009, entitled Fluid Level Monitoring System, filed Dec. 29, 2023, and hereby incorporates this application by reference herein in its entirety.

### TECHNICAL FIELD

The present disclosure relates to fluid level monitoring systems, and more particularly to a fluid level monitoring system that utilizes a capacitance-controlled oscillator that is tuned to be unstable for accurate and cost-effective fluid level detection.

### BACKGROUND

Fluid level monitoring plays an important role in many industrial, medical, and consumer applications. Accurate measurement of fluid levels in containers can contribute to proper operation, maintenance, and safety in various settings, from manufacturing plants to healthcare facilities. Traditional fluid level sensing technologies have relied on a variety of methods, including float switches, optical sensors, and ultrasonic devices which have limitations including potential mechanical failures, sensitivity to fluid properties, and cost or calibration complexities.

Capacitive sensing techniques can be used as an alternative to these traditional methods because of their ability to provide non-invasive measurement, compatibility with a wide range of fluids, and the ability to work with non-metallic containers. However, implementing accurate and cost-effective capacitive sensing systems has challenges, particularly in terms of signal processing and the need for specialized components which can be expensive.

### BRIEF DESCRIPTION OF THE DRAWINGS

FIG. 1 is a block diagram depicting a fluid level monitoring system;

FIG. 2 is a schematic view depicting an oscillator circuit for generating a variable frequency signal based on capacitance changes, according to one embodiment; and

FIG. 3 is a schematic view depicting a conventional oscillator circuit.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Described herein are example embodiments of a fluid level monitoring system that provides a solution for accurately measuring fluid levels in containers, which is particularly suited for mobile treatment carts in medical and dental settings. The fluid level monitoring system can include a probe that is inserted into the container for monitoring its fluid level. The probe can have two wires that are separated from each other by insulation. The fluid stored in the fluid container can serve as a dielectric medium for the two wires such that the capacitance between the two wires varies as a function of the fluid level in the container. The capacitance can be fed to an oscillator that generates a frequency modulated output signal that has a frequency that varies as a function of the change in the capacitance of the probe. A microprocessor can analyze the frequency of the frequency modulated output signal to determine the fluid level of the container. In the illustrated embodiments, although a fluid container is shown and described for use in a dental or medical setting, it is to be appreciated that the principles and features described herein can be employed in any setting for detecting a fluid level of a container or other reservoir.

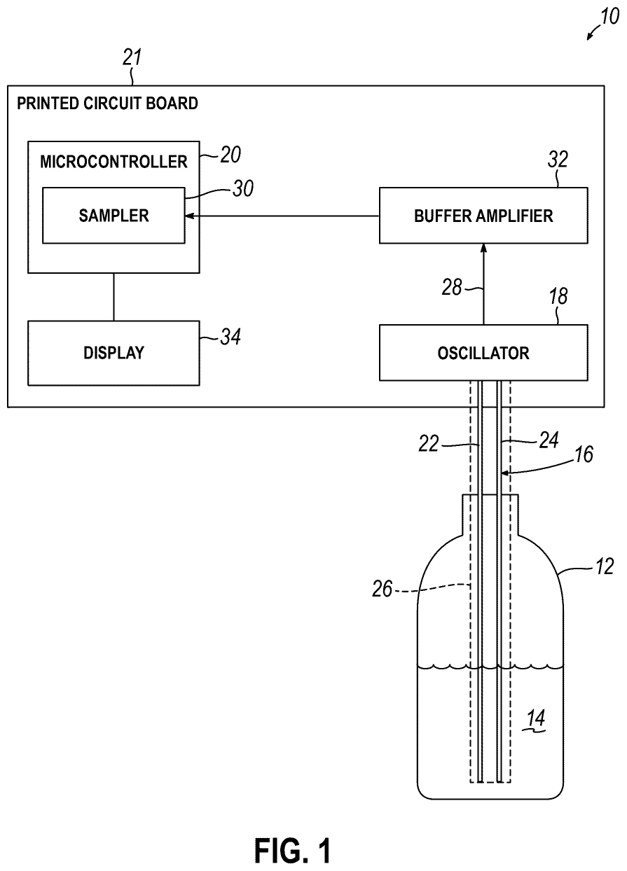

Embodiments are hereinafter described in detail in connection with the views and examples of FIGS. 1-3, wherein like numbers indicate the same or corresponding elements throughout the views. A fluid level monitoring system 10 is generally depicted in FIG. 1 in association with a fluid container 12 for detecting a level of fluid 14 contained within the fluid container 12. The fluid container 12 is shown as a generic bottle but can be understood to represent any type of fluid container where the fluid 14 is dispensed from the fluid container 12 and accurate measurement of the level of the fluid 14 in the fluid container 12 is important. In one embodiment, the fluid container 12 and the fluid 14 can be part of a medical or dental system fluid dispensing system, such as, for example, an air-water syringe, an ultrasonic scaler, and dental handpieces.

The fluid level monitoring system 10 can include a probe 16, an oscillator 18, and a microcontroller 20. The oscillator 18 and the microcontroller 20 can be mounted on a printed circuit board (PCB) 21 that is housed within a protective enclosure (not shown). The PCB 21 can be designed to accommodate the specific layout requirements of the fluid level monitoring system 10, allowing for efficient interconnection between components. The protective enclosure may be constructed from materials suitable for the intended operating environment, such as plastic or metal, and may provide protection against dust, moisture, or other potential contaminants. In some embodiments, the enclosure may include mounting features to facilitate installation of the fluid level monitoring system 10 in various applications, such as mobile treatment carts or stationary equipment. The PCB 21 and the protective enclosure can allow for easy access to connection points for the probe 16 and any necessary power or data interfaces.

The probe 16 can be electrically coupled with the oscillator 18 and can be installed in the fluid container 12 to facilitate measurement of the level of the fluid 14 contained therein. The probe 16 can include a first wire 22 and a second wire 24 that are routed adjacent to, and substantially in parallel with, each other. The first and second wires 22, 24 can be housed in an insulating jacket 26 that is formed of PVC or other suitable material that prevents the first and second wires 22, 24 from electrically contacting each other. The first and second wires 22, 24 can be configured to have a capacitance therebetween. When the probe 16 is installed in the fluid container 12, as illustrated in FIG. 1, the fluid 14 can serve as a dielectric for each of the first and second wires 22, 24 such that the capacitance of the probe 16 varies as a function of the amount of the fluid 14 that surrounds the probe 16. Because the amount of fluid surrounding the probe 16 is determined by the level of the fluid 14, the capacitance of the probe 16 can be indicative of the level of the fluid 14 and can be utilized to monitor the fluid level, as will be described in further detail below. In some embodiments, the capacitance of the probe 16 can be parasitic (e.g., between 85 pF and 120 pF).

In one embodiment, conventional speaker wire can be utilized for the probe 16. In such an embodiment, the first and second wires 22, 24 can comprise a stranded twisted conductor with the insulating jacket 26 being formed of PVC or other suitable material. Each stranded twisted conductor may be between 12 AWG and 18 AWG, although other wire thicknesses are contemplated. Utilizing conventional speaker wire for the probe 16 can be a cost-effective approach that is easy to implement in the fluid level monitoring system 10.

The level of the fluid 14 and the capacitance of the probe 16 can have an inverse relationship such that increasing or decreasing of the level of the fluid 14 can cause the capacitance of the probe 16 to decrease or increase, respectively. In one embodiment, the relationship between the level of the fluid 14 at the probe 16 and the capacitance of the probe 16 can be inversely proportional. In such an embodiment, the fluid level-capacitance relationship can generally conform to a negatively sloped linear curve but can deviate therefrom by an acceptable tolerance (e.g., +5%). In alternative embodiments, the fluid level-capacitance relationship might conform to a non-linear curve, such as an exponential or sigmoidal (S-shaped) curve, for example.

The oscillator 18 can be electrically coupled with the microcontroller 20 via a signal output 28. The oscillator 18 can receive the capacitance from the probe 16 and can generate a frequency modulated output signal (e.g., output signal) in response that is delivered to the microcontroller 20 via the signal output 28. The frequency of the output signal can vary as a function of the capacitance of the probe 16 such that the level of the fluid 14 can be determined from the frequency of the output signal. The capacitance of the probe 16 and the frequency of the output signal can have a direct relationship such that increasing or decreasing the capacitance of the probe 16 can cause the frequency of the output signal to increase or decrease, respectively. In one embodiment, the relationship between the capacitance of the probe 16 and the frequency of the output signal can be proportional. In such an embodiment, the capacitance-frequency relationship can generally conform to a positively sloped linear curve but can deviate therefrom by an acceptable tolerance (e.g., +5%). In alternative embodiments, the capacitance-frequency relationship can conform to a non-linear curve, such as an exponential or sigmoidal (S-shaped) curve, for example.

The output signal can operate within a predefined frequency range that has an upper limit that corresponds to the fluid container 12 being empty and a lower limit that corresponds to the fluid container 12 being full. The difference between the upper limit and the lower limit can define a bandwidth of the frequency range. In one embodiment, the frequency range can have a bandwidth of about 55 kHz, a lower limit of between about 480 kHz and 520 kHz and an upper limit of between about 535 kHz and 575 kHz. A lower limit of about 480 kHz and an upper limit of about 535 kHz will be discussed herein for purposes of illustration. It is to be appreciated that any of a variety of suitable alternative frequency ranges and/or bandwidths can be implemented for detecting the level of the fluid 14 in the fluid container 12 as a function of frequency.

The microcontroller 20 can be configured to determine the amount of fluid proximate the probe 16 based on the frequency of the output signal. The microcontroller 20 can include a sampler 30 that receives the output signal from the oscillator 18. The sampler 30 can sample the output signal at a predefined sampling rate to detect the frequency of the output signal which the microcontroller 20 can then use to determine the level of the fluid 14 that is present in the fluid container 12. For example, if the detected frequency is about 480 kHz, the microcontroller 20 can determine that the fluid container 12 is full or nearly full. If the detected frequency is about 507 kHz, the microcontroller 20 can determine that the fluid container 12 is about half full. If the detected frequency is about 535 kHz, the microcontroller 20 can determine that the fluid container 12 is empty or nearly empty. The microcontroller 20 can use a lookup table, an algorithm, or other correlation data in order to correlate the detected frequency to a particular fluid level.

A buffer amplifier 32 can be electrically coupled with each of the oscillator 18 and the microcontroller 20 and can condition the output signal from the oscillator 18 prior to delivery to the microcontroller 20. The buffer amplifier 32 can transform the output signal into a format that is suitable for delivery to the microcontroller 20. For example, the output signal can be a generally sinusoidal signal that has negative voltage transitions (e.g., troughs) which if transmitted to the microcontroller 20 could cause it to malfunction and even fail. The buffer amplifier 32 can filter out the negative voltage transitions such that the output signal is delivered to the microcontroller 20 in a suitable format. In one embodiment, the buffer amplifier 32 can be a Darlington pair.

Still referring to FIG. 1, a display 34 can be associated with the microcontroller 20 for presenting fluid level information to a user. The display 34 may be an LCD, one or more LEDs, or other suitable type of visual output device. The microcontroller 20 can process the output signal from the oscillator 18 and send corresponding signals to the display 34 to display the current level of the fluid 14 in the fluid container 12. The display 34 may present the fluid level information in various formats, such as numerical percentages, graphical representations, or color-coded indicators. In some embodiments, the display 34 may additionally or alternatively show trend information or alerts when fluid levels reach certain thresholds. The display 34 can be incorporated directly into the fluid level monitoring system 10 by being directly mounted to the PCB 21, or alternatively on a separate PCB and coupled with the microcontroller 20 by a cable. Additionally or alternatively, the display 34 can be incorporated on a remote computing device, such as a smart phone, that receives the signals from the microcontroller 20 via wireless communication (e.g., Bluetooth or WiFi). In some cases, the fluid level monitoring system 10 may include an alarm feature that generates an audible and/or visual alarm, either on the display 34 or on a separate device, that notifies the user when the fluid container 12 is empty and thus needs to be refilled or replaced. The inclusion of a display and/or alarm feature may enhance the usability of the fluid level monitoring system 10 by providing real-time, easily interpretable feedback to a user in applications where monitoring fluid levels is important.

In one embodiment, the display 34 can display the current level of the fluid as discrete magnitudes of fullness (e.g., empty, 25% full, 50% full, 75% full, and 100% full). In such an embodiment, the microcontroller 20 can categorize the fluid level into predefined ranges based on the detected frequency and cause the appropriate discrete magnitude of fullness to be presented on the display 34. For example, if the detected frequency is between about 480 kHz and 491 kHz, the microcontroller 20 can cause the display 34 to indicate that the fluid container 12 is empty. If the detected frequency is between about 492 kHz and 502 kHz, the microcontroller 20 can cause the display 34 to indicate that the fluid container 12 is 25% full. If the detected frequency is between about 503 kHz and 514 kHz, the microcontroller 20 can cause the display 34 to indicate that the fluid container 12 is 50% full. If the detected frequency is between about 515 kHz and 525 kHz, the microcontroller 20 can cause the display 34 to indicate that the fluid container 12 is 75% full. If the detected frequency is between about 526 kHz and 535 kHz, the microcontroller 20 can cause the display 34 to indicate that the fluid container 12 is 100% full. Displaying the fluid level in discrete magnitudes in this manner can alleviate the need for highly precise detection of the frequency of the output signal.

In some cases, the fluid level monitoring system 10 can include a calibration feature that enables a user to calibrate the device in the field. Initially, the probe 16 may be placed into an empty bottle, and the resulting frequency of the output signal can be set as a base measurement. In one embodiment, the system can algorithmically extrapolate the frequencies that correlate to the 25%, 50%, 75%, and 100% full amounts. In another embodiment, the system can instead record additional measurements with the bottle filled to different levels, such as 25%, 50%, 75%, and 100% capacity. In either embodiment, a calibration curve or lookup table can be created within the microcontroller 20 for later use. The system may also incorporate a self-calibration feature, allowing for periodic recalibration during use to maintain accuracy over time. The calibration feature can enable the fluid level monitoring system 10 to be adapted to different types of probe wires, different fluid properties, and/or different containers, thus enhancing its versatility across different applications.

To enhance practicality, efficiency, and overall affordability, the fluid level monitoring system 10 can be constructed with inexpensive components such as simple speaker wire for the probe 16 and a commercial-off-the-shelf low grade microprocessor (e.g., a 32-Bit Single-Core 120 MHz 1 MB IC) for the microcontroller 20. However, one limitation of using inexpensive components like this, specifically the microcontroller 20, is that the sampling rate of the sampler 30 is typically not sufficient enough to accurately determine the frequency of the output signal from the oscillator 18. According to the Nyquist theorem, the sampling rate for a signal should be at least twice the highest frequency present in a signal to be able to accurately sample the signal. This prevents aliasing-a phenomenon where higher frequencies are incorrectly mapped to lower frequencies. However, by constructing the fluid level monitoring system 10 with inexpensive components, the sampling rate of the sampler 30 can be less than the Nyquist requirement of the oscillator 18 which can cause aliasing. It is to be appreciated that while a more expensive and sophisticated microcontroller could be used to prevent such aliasing, this would increase cost and introduce additional complexity into the fluid level monitoring system 10.

To overcome this limitation without replacing the simplified and low-cost microcontroller 20 with a more expensive and sophisticated microcontroller, the oscillator 18 can be purposefully tuned to be unstable such that the output signal is unstable which can generate significant fluctuations in the output signal that are generally random and unpredictable (as opposed to a stable, periodic signal). The output signal, however, can still be generally sinusoidally shaped and can oscillate about a center frequency. In one embodiment, the unstable output signal can oscillate about the center frequency between an upper limit that is 5 kHz greater than the center frequency and a lower limit that is 5 kHz less than the center frequency (e.g., a 10 KHz “window”).

The instability introduced into the oscillator 18 allows the sampler 30 to sample the waveform of the output signal randomly and at a sampling rate that is below the Nyquist rate of the oscillator 18. In doing so, the microcontroller 20 can effectively obtain a lower-frequency replica of the original center frequency which it can then extrapolate to the higher frequency original. The microcontroller 20 can thus use the data points sampled by the sampler 30 to determine (i.e., extrapolate) the center frequency of the waveform which can be understood to be the detected frequency described above for use in determining the fluid level of the fluid container 12. The data collection and averaging by the microcontroller 20 can cause a slight delay (e.g., less than one second) in the determination of the fluid level that is effectively negligible to a user. This delay is effectively inconsequential because, in most settings, the fluid 14 is withdrawn slowly enough that true real time detection is not necessary.

The instability in the oscillator 18 can be intentionally achieved by omitting or modifying some of the electrical components of a conventional Hartley oscillator. This can be achieved in various ways. For instance, in a transistor-based Hartley oscillator, setting the transistor near its cut-off or saturation region can lead to irregular oscillations due to the non-linear response in these regions. Altering the feedback network, which is crucial for sustaining oscillations, by changing the phase or magnitude of feedback can also introduce instability. This might involve using components that change their values with temperature or voltage. Introducing variability in the power supply voltage can make the oscillator output unstable, which can be achieved through controlled introduction of noise or fluctuations in the supply. Using components with wide tolerance ranges or that are prone to drift over time, like resistors or capacitors, can also induce instability as these component values change. Designing the circuit to be sensitive to temperature variations by using temperature-sensitive components in the biasing network, can also contribute to instability. Incorporating non-linear components like varactors, diodes, or certain types of transistors, especially when biased in their non-linear regions, can make the output unstable. Injecting noise into the circuit using noise-generating components or circuits, either at the input or within the feedback loop, can result in an unstable output. Finally, dynamically changing the load seen by the oscillator can also introduce instability, with the load changing in response to certain conditions or signals. It is to be appreciated that tuning the oscillator 18 to be unstable contemplates all of the foregoing and similar related techniques. It is also to be appreciated that by utilizing this configuration, the fluid level monitoring system 10 can offer an accurate, cost-effective, and adaptable solution for fluid level sensing in various applications, particularly in medical and dental settings where precise fluid management is crucial.

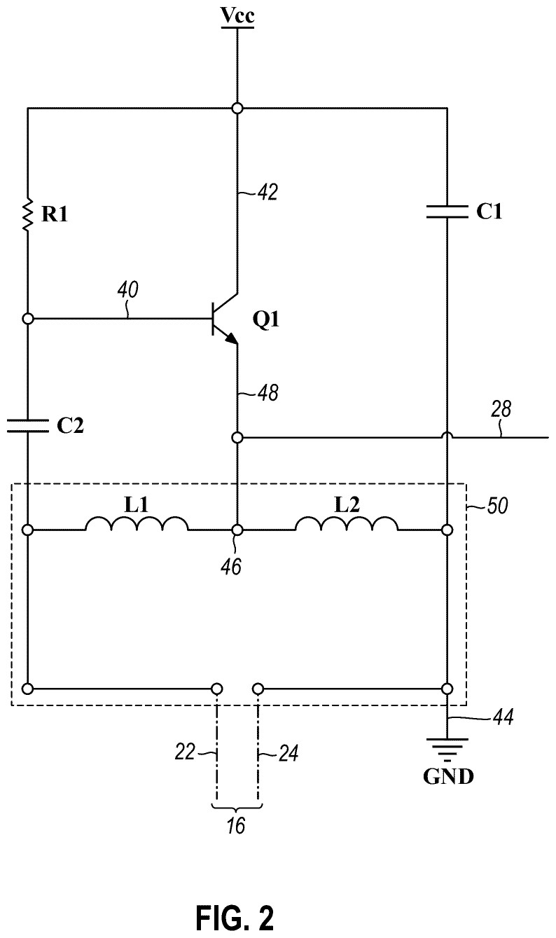

Referring now to FIG. 2, a circuit diagram of the oscillator 18 is shown and will now be described. The oscillator 18 can include a resistor R1, a capacitor C1, a transistor Q1, a feedback capacitor C2, a first inductor L1, and a second inductor L2. The resistor R1 can be electrically coupled with a power supply (Vec) and a base 40 of the transistor Q1. The capacitor C1 can be electrically coupled with a collector 42 of the transistor Q1 and a ground 44. The first inductor L1 and the second inductor L2 can be electrically coupled together at one end at a node 46 that is also electrically coupled to an emitter 48 of the transistor Q1 such that the first and second inductors L1, L2 and the emitter 48 are electrically coupled together. The opposite end of the first inductor L1 (e.g., the end that is opposite the node 46) can be electrically coupled with the first wire 22 and with the feedback capacitor C2 that is connected at an opposite end to the base 40 of the transistor Q1. The opposite end of the second inductor L2 (e.g., the end that is opposite the node 46) can be electrically coupled with the capacitor C1, the ground 44, and the second wire 24. The first and second inductors L1, L2 and the first and second wires 22, 24 can define a resonant tank 50 where the first and second wires 22, 24 serve as the capacitive element of the resonant tank 50. The signal output 28 can be electrically connected to the emitter 48 such that the output signal is transmitted to the microcontroller 20 from the emitter 48.

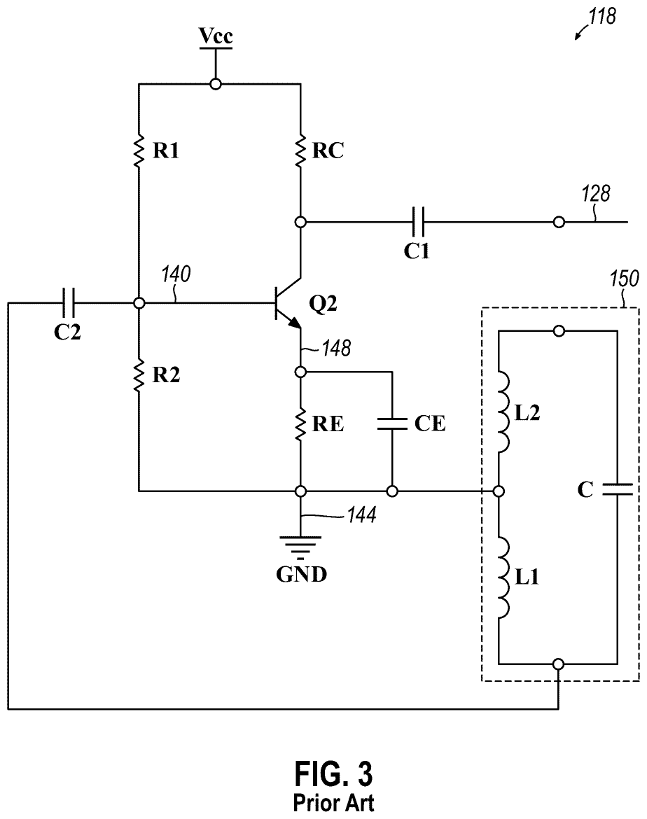

As described above, the configuration of the oscillator 18 can cause the output signal to be generally unstable. FIG. 3 illustrates a conventional Hartley oscillator 118 that is similar to the oscillator 18 but that is configured to be stable. For example, the conventional Hartley oscillator 118 can include a resistor RE and a capacitor CE that is connected between an emitter 148 of transistor Q1 and a ground 144. A resistor R2 can be connected to a base 140 of the transistor Q2 and the ground 144. A resistor RC can be connected between a base 140 of the transistor Q1 and a power supply. A resonant tank 150 can be coupled at one side to the ground 144 and can include capacitor C. A signal output 128 can be coupled with the resonant tank 150. It is to be appreciated these components and the configuration of the circuit can induce stability into the conventional Hartley oscillator 118.

By comparison, however, the oscillator 18 of FIG. 2 can be intentionally designed to be unstable by modifying the conventional Hartley oscillator 118 shown in FIG. 3. For example, the emitter 48 can be directly coupled with the resonant tank 50 in lieu of the resistor RE and the capacitor CE shown in FIG. 3. The path between the base 40 and the resonant tank 50 can be devoid of a resistor (e.g., R2 shown in FIG. 3). The power supply Vcc and the collector 42 can be devoid of a resistor (e.g., resistor RC shown in FIG. 3) and instead directly connected together. The resonant tank 50 can instead be grounded at inductor L2. The signal output 28 can be connected to the emitter 48 instead of the collector 42. And the capacitor that would otherwise be present in the resonant tank 50 (e.g., capacitor C shown in FIG. 3) can be replaced with the first and second wires 22, 24. By configuring the oscillator 18 in this manner, instability can be intentionally introduced into the output signal to allow for the sampling of the output signal described above.

The oscillator 18 can therefore provide sensitivity, adaptability, and cost-effectiveness for fluid level monitoring applications. The fluid level monitoring system 10 of the present disclosure thus provides a cost-effective solution for fluid level monitoring by using conventional off the shelf components like speaker wire for the probe 16 and a low grade microprocessor for the microcontroller 20. The fluid level monitoring system 10 can also be highly adaptable because the system can be calibrated to a particular environment (e.g., a specific probe, fluid, and/or container type) which allows the system to be used in a wide range of applications and environments.

The fluid level monitoring system 10 may be particularly suitable for medical and dental settings. The system's ability to provide real-time fluid level information may help medical professionals maintain appropriate fluid supplies during procedures. In some cases, the fluid level monitoring system may overcome limitations of traditional fluid level sensors. By utilizing parasitic capacitance and introducing controlled instability in the oscillator, the system may achieve accurate measurements without the need for expensive, high-precision components. This approach may allow for improved sensitivity to small changes in fluid levels while maintaining cost-effectiveness. The fluid level monitoring system may have potential applications beyond medical use. In some cases, the system may be adapted for use in industrial settings, such as monitoring chemical levels in storage tanks. The system's ability to function in various environments may make it suitable for agricultural applications, such as monitoring water levels in irrigation systems.

In some cases, the fluid level monitoring system may offer improved reliability compared to traditional sensors. The simplicity of the design, with fewer components, may reduce the potential points of failure. Additionally, the system's ability to function effectively with lower-cost components may make it more accessible for a wider range of applications where cost is a significant factor.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A fluid level monitoring system, comprising:
a microcontroller;
an oscillator configured to generate an output signal having a frequency; and
a probe coupled with the oscillator and comprising a first wire and a second wire having a capacitance therebetween that varies as a function of the presence of fluid around the probe, wherein:
the frequency of the output signal varies as a function of the capacitance between the two wires; and
the microcontroller is configured to determine an amount of fluid proximate the probe based on the frequency of the output signal.

2. The fluid level monitoring system of claim 1, wherein:
the frequency of the output signal comprises a center frequency;
the oscillator is tuned to be unstable such that the output signal is unstable about the center frequency; and
the microcontroller is configured to periodically sample the output signal to determine the center frequency.

3. The fluid level monitoring system of claim 2, wherein the microcontroller comprises a sampler configured to sample the output signal at a sampling rate that is below a Nyquist requirement of the oscillator.

4. The fluid level monitoring system of claim 3, wherein the microcontroller is configured to extrapolate the center frequency from the samples of the output signal.

5. The fluid level monitoring system of claim 2, wherein the output signal is unstable about the center frequency between an upper limit and a lower limit.

6. The fluid level monitoring system of claim 5, wherein the upper limit is about 5 kHz greater than the center frequency and the lower limit is about 5 kHz less than the center frequency.

7. The fluid level monitoring system of claim 1, further comprising a buffer amplifier electrically coupled with each of the microcontroller and the oscillator, wherein the buffer amplifier is configured to condition the output signal from the oscillator prior to delivery to the microcontroller.

8. The fluid level monitoring system of claim 1, wherein the first wire and the second wire each comprises a stranded twisted conductor that is surrounded by an insulating jacket.

9. The fluid level monitoring system of claim 8, wherein each stranded twisted conductor is between 12 AWG and 18 AWG and each insulating jacket is formed of PVC.

10. The fluid level monitoring system of claim 1, wherein:
the oscillator comprises a resonant tank circuit that comprises a first inductor, a second inductor, and the probe; and
the first inductor and the second inductor are each electrically coupled together at one end;
an opposite end of the first inductor is electrically coupled with the first wire; and
an opposite end of the second inductor is electrically coupled with the second wire.

11. A method for monitoring a fluid level of a container, the method comprising:
generating an output signal on a probe by an oscillator, the probe being disposed in a fluid container and having a capacitance that varies as a function of the presence of fluid around the probe;
detecting, by a microcontroller, a frequency of the output signal, the frequency being varied as a function of the capacitance between the two wires; and
determining, by the microcontroller, the amount of fluid proximate the probe based on the detected frequency of the output signal.

12. The method of claim 11, wherein the frequency of the output signal comprises a center frequency and the output signal is unstable about the center frequency, the method further comprising periodically sampling the output signal to determine the center frequency.

13. The method of claim 12, wherein periodically sampling the output signal further comprises sampling the output signal at a sampling rate that is below a Nyquist requirement of the oscillator.

14. The method of claim 13, wherein the microcontroller is configured to extrapolate the center frequency from the samples of the output signal.

15. The method of claim 11, further comprising conditioning the output signal from the oscillator prior to delivery to the microcontroller.

16. The method of claim 11, wherein determining the amount of fluid proximate the probe further comprises categorizing, by the microcontroller, the amount of fluid proximate the probe into predefined ranges based on the frequency of the output signal.

17. A fluid level monitoring system, comprising:
a microcontroller;
an oscillator configured to generate an output signal that oscillates about a center frequency; and
a probe coupled with the oscillator and having a capacitance therebetween that varies as a function of the presence of fluid around the probe, wherein:
the center frequency of the output signal varies as a function of the capacitance; and
the microcontroller is configured to determine an amount of fluid proximate the probe based on the center frequency of the output signal; and
the oscillator is tuned to be unstable such that the output signal is unstable about the center frequency.

18. The fluid level monitoring system of claim 17, wherein the microcontroller is configured to periodically sample the output signal to determine the center frequency.

19. The fluid level monitoring system of claim 18, wherein the microcontroller comprises a sampler configured to sample the output signal at a sampling rate that is below a Nyquist requirement of the oscillator.

20. The fluid level monitoring system of claim 19, wherein the microcontroller is configured to extrapolate the center frequency from the samples of the output signal.
